(19) United States
(12) Patent Application Publication
(10) Pub. No.: US 2012/0289439 A1
(43) Pub. Date: Nov. 15, 2012

(54) PROCESS FOR THE MANUFACTURE OF SULPHIDE COMPOUNDS

(76) Inventors: Carolus Matthias Anna Maria Mesters, Sugar Land, TX (US); Joseph Broun Powell, Houston, TX (US); Ronald Jan Schoonebeek, Amsterdam (NL); Dean Chien Wang, Missouri City, TX (US)

(21) Appl. No.: 13/519,720

(22) PCT Filed: Jan. 5, 2011
(86) PCT No.: PCT/US11/20167

§ 371 Date: Jun. 28, 2012

Related U.S. Application Data
(60) Provisional application No. 61/293,063, filed on Jan. 7, 2010.

(51) Int. Cl. C01B 31/26; C09K 8/58

(52) U.S. Cl. 507/202; 423/443; 507/269

(57) ABSTRACT

A process for the manufacture of carbon disulphide comprising the following steps reacting carbon dioxide with hydrogen sulphide to form carbonyl sulphide and water; and absorbing at least a portion of the water with a sorbent, leaving a mixture comprising carbonyl sulphide, carbon dioxide, and hydrogen sulphide.

### FIELD OF THE INVENTION

The invention provides a process for the manufacture of carbon disulphide and/or carbon oxysulfide.

### BACKGROUND OF THE INVENTION

Carbon disulphide is typically manufactured by reacting light saturated hydrocarbons with elemental sulphur that is in the vapour phase according to the reaction equation:

CₙH₂₍ₙ₊₁₎+(3n+1)S→nCS₂+(n+1)H₂S

It is also known to manufacture carbon disulphide by catalytically reacting liquid sulphur with a hydrocarbon.

Carbon oxysulphide is typically manufactured by reacting carbon dioxide with elemental sulphur.

U.S. Pat. No. 7,426,959 discloses a system including a mechanism for recovering oil and/or gas from an underground formation, the oil and/or gas comprising one or more sulfur compounds; a mechanism for converting at least a portion of the sulfur compounds from the recovered oil and/or gas into a carbon disulfide formulation; and a mechanism for releasing at least a portion of the carbon disulfide formulation into a formation. U.S. Pat. No. 7,426,959 is herein incorporated by reference in its entirety.

Co-Pending Patent Application PCT/US2009/031762, having attorney docket number TH3443, discloses a system including a mechanism for recovering oil and/or gas from an underground formation, the oil and/or gas comprising one or more sulfur compounds; a mechanism for converting at least a portion of the sulfur compounds from the recovered oil and/or gas into a carbon oxysulfide formulation; and a mechanism for releasing at least a portion of the carbon oxysulfide formulation into a formation. Co-Pending Patent Application PCT/US2009/031762 is herein incorporated by reference in its entirety.

Co-Pending Patent Application WO 2007/131976, having attorney docket number TS1746, discloses a process for the manufacture of carbon disulphide comprising supplying a feedstock comprising a hydrocarbonaceous compound to a reaction zone containing a liquid elemental sulphur phase and reacting, in the liquid sulphur phase, at a temperature in the range of from 350 to 750° C. and a pressure in the range of from 3 to 200 bar (absolute) and in the absence of a catalyst, the hydrocarbonaceous compound with elemental sulphur in the absence of molecular oxygen. The invention further provides the use of a liquid stream comprising carbon disulphide and hydrogen sulphide obtainable by such process for enhanced oil recovery. Co-Pending Patent Application WO 2007/131976 is herein incorporated by reference in its entirety.

Co-Pending Patent Application WO 2008/003732, having attorney docket number TS1818, discloses a process for the manufacture of carbon disulphide by reacting carbon dioxide with elemental sulphur to form carbonyl sulphide and disproportionating the carbonyl sulphide formed into carbon disulphide and carbon dioxide, the process comprising contacting a gaseous stream comprising carbon dioxide with a liquid elemental sulphur phase containing a solid catalyst at a temperature in the range of from 250 to 700° C. to obtain a gaseous phase comprising carbonyl sulphide, carbon disulphide and carbon dioxide. Co-Pending Patent Application WO 2008/003732 is herein incorporated by reference in its entirety.

Co-Pending Patent Application WO 2007/131977, having attorney docket number TS1833, discloses a process for the manufacture of carbon disulphide comprising supplying a molecular oxygen-containing gas and a feedstock comprising a hydrocarbonaceous compound to a reaction zone containing a liquid elemental sulphur phase and reacting, in the liquid sulphur phase, at a temperature in the range of from 300 to 750° C., the hydrocarbonaceous compound with elemental sulphur to form carbon disulphide and hydrogen sulphide and oxidising at least part of the hydrogen sulphide formed to elemental sulphur and water. The invention further provides the use of a liquid stream comprising carbon disulphide, hydrogen sulphide and carbonyl sulphide obtainable such process for enhanced oil recovery. Co-Pending Patent Application WO 2007/131977 is herein incorporated by reference in its entirety.

There is a need in the art for one or more of the following:

A direct synthesis of carbon oxysulfide and/or carbon disulfide without the need for elemental sulphur;

A new method to convert carbon dioxide into another chemical;

A new method to convert hydrogen sulfide into another chemical;

A new method to manufacture chemical mixtures for enhanced oil recovery (EOR);

An alternative method to manufacture carbon oxysulfide; and/or

An alternative method to manufacture carbon disulfide.

These and other needs will become apparent to those of skill in the art upon review of this specification, including its drawings and claims.

### SUMMARY OF THE INVENTION

One aspect of the invention provides a process for the manufacture of carbon disulphide comprising the following steps reacting carbon dioxide with hydrogen sulphide to form carbonyl sulphide and water; and absorbing at least a portion of the water with a sorbent, leaving a mixture comprising carbonyl sulphide, carbon dioxide, and hydrogen sulphide.

It has now been found that carbon disulphide can be manufactured from carbon dioxide by reacting carbon dioxide with hydrogen sulphide to form carbonyl sulphide and water and then disproportionating the carbonyl sulphide formed into carbon disulphide and carbon dioxide.

Accordingly, the invention provides a process for the manufacture of carbon disulphide comprising the following steps:
(a) reacting carbon dioxide with hydrogen sulphide to form carbonyl sulphide and water, and then removing the water with a sorbent;
(b) contacting the carbonyl sulphide formed in step (a) with a catalyst effective for disproportionating carbonyl sulphide into carbon disulphide and carbon dioxide.

An advantage of the process according to the invention as compared to the conventional carbon disulphide manufacturing process using hydrocarbons as carbon source is that less hydrogen sulphide is formed that would have to be recycled to a Claus unit for conversion into sulphur.

Another advantage is that hydrogen sulphide is typically available at synthesis gas production locations, as a component of acid gas, or as a waste stream from gas treatments or industrial processes. Likewise, carbon dioxide is typically available at synthesis gas production locations, as a component of acid gas, or as a waste stream from gas treatments or industrial processes. This process takes the hydrogen sulphide and carbon dioxide streams and converts them to a more desirable COS and/or CS₂ stream.

### DETAILED DESCRIPTION OF THE INVENTION

Step (A):

In the process according to the invention, carbon dioxide is first reacted with hydrogen sulphide to form carbonyl sulphide and hydrogen according to:

CO₂+H₂S←→COS+H₂O (1)

This reaction is known in the art, and may be carried out in any suitable way known in the art. Typically, the reaction will be carried out by contacting gaseous carbon dioxide and gaseous hydrogen sulphide with a catalyst, in the presence of a sorbent. Suitable catalysts are for example mixed metal sulphides, and sulphides of transition metals, in particular silica-supported metal sulphides. Other suitable catalysts include silica, amorphous silica alumina (ASA) commercially available from CRI, and zeolyte catalysts such as ZSM-5 commercially available from Zeolyst International. Suitable sorbents include silica, silica gel, and mole sieves such as Molsiv 13X commercially available from UOP.

In one embodiment, step (a) may be performed on acid gas, which may include portions of methane, hydrogen sulphide and carbon dioxide. Step (a) may therefore remove hydrogen sulphide and carbon dioxide and convert it to carbon oxysulfide, and leave behind a higher purity methane or natural gas.

Typical reaction temperatures for step (a) are in the range of from 120 to 750° C.

In operation, step (a) may be performed in the presence of a sorbent which selectively absorbs water, pushing the equilibrium of the reaction to produce more carbon oxysulfide. Periodically, the saturated sorbent is removed from the reactor and regenerated to remove the water. In one embodiment, a two or more train swing bed is used in which one bed of sorbent is used in the reactor until it has been saturated, at which point it is replaced by another bed of sorbent in the reactor, while the first bed is dried to remove the water. In another embodiment, the sorbent may be removed and sent and to a regenerator to be dried, and then recycled for use again. In one embodiment, the sorbent may also function as a catalyst in the reaction.

In one embodiment, at the end of step (a), the water has been substantially removed with the use of a sorbent, leaving COS and unreacted CO₂ and H₂S. Selective acid gas absorption may be used to absorb the unreacted CO₂ and H₂S, and then sending the COS to step (b). The unreacted CO₂ and H₂S could then be recycled through the reactor of step (a), by a low temperature distillation/fractionation to recover the CO₂ and H₂S from the suitable selective acid gas absorption medium. One suitable selective acid gas absorption medium is an amine. Other separation techniques known in the art may also be used to separate COS from the CO₂ and H₂S, such as cryogenic separation or with a membrane or a catalytic membrane.

In another embodiment, at the end of step (a), the water has been substantially removed with the use of a sorbent, leaving COS and unreacted CO₂ and H₂S. The COS, CO₂,and H₂S mixture may be injected into a hydrocarbon containing formation to boost the recovery of hydrocarbons from the reservoir. One suitable system and method of EOR with a COS mixture is disclosed in co-pending WO patent publication WO 2009/97217, having attorney docket number TH3443, which is herein incorporated by reference in its entirety.

Alternatively, the COS, CO₂,and H₂S mixture may be injected into an underground formation to sequester the sulphur and/or carbon, instead of releasing it into the atmosphere.

In one embodiment, step (a) may be used for sour gas or acid gas purification.

Step (B):

The carbonyl sulphide formed in step (a) of the process according to the invention is then contacted in step (b) with a catalyst effective for disproportionating carbonyl sulphide into carbon disulphide and carbon dioxide according to:

2COS [symbol] CS₂+CO₂ (2)

Preferably, the water formed in step (a) is separated from the carbonyl sulphide formed in step (a) with the use of a sorbent before the carbonyl sulphide is disproportionated.

Catalysts effective for disproportionation of carbonyl sulphide are known in the art, such as catalysts with one or more metal oxides. Examples of suitable catalysts are alumina, titania, alumina-titania, silica-alumina, quartz, or clay, for example kaolin. The catalyst may have a specific surface area of at least 50 m²/g, such as at least 100 m²/g, or at least 200 m²/g. Other suitable catalysts are gamma-alumina, titania, alumina-titania, or silica-alumina. These same catalysts for use in step (b) could also be used in step (a).

The reaction conditions under which the carbonyl sulphide is contacted with the disproportionation catalyst may be any reaction conditions known to be suitable for that reaction.

Disproportionation reaction (2) is a thermodynamically unfavourable, reversible reaction. Since the heat of reaction is close to zero, the equilibrium constant does not change much with temperature. If desired, the carbonyl sulphide conversion can be increased by removing carbon disulphide from the reaction mixture, for example by solvent extraction or condensation.

The carbon dioxide that is reacted with hydrogen sulphide in step (a) may be carbon dioxide from any suitable source.

In one embodiment of the invention, the feedstock for step (a) is natural gas that comprises hydrogen sulphide, i.e. sour natural gas, and at least part of the hydrogen sulphide that is reacted with carbon dioxide in step (a) is hydrogen sulphide that is separated from the natural gas. Separation of hydrogen sulphide from a natural gas feedstock that comprises hydrogen sulphide may done by any suitable technique known in the art, for example by physical absorption in an organic solvent followed by solvent regeneration.

In step (b) of the process according to the invention, carbon disulphide and carbon dioxide are formed. The carbon disulphide may be separated from the carbon dioxide and the unreacted carbonyl sulphide, for example by condensation or solvent extraction. Alternatively, a mixture comprising carbon disulphide, carbon dioxide and unreacted carbonyl sulphide may be obtained. The unreacted carbonyl sulphide may be recycled to step (b), and the carbon dioxide may be recycled to step (a).

Carbon disulphide that is separated from the carbon dioxide and the unreacted carbonyl sulphide may be used for conventional applications of carbon disulphide, for example as an enhanced oil recovery agent, as a raw material for rayon production or as solvent.

In one embodiment, the process according to the invention further comprises injecting at least part of the carbon disulphide formed in step (b) in an oil reservoir for enhanced oil recovery. The carbon disulphide injected may be relatively pure carbon disulphide that is separated from the carbon dioxide formed and from the unreacted carbonyl sulphide. For enhanced oil recovery, it is however not necessary to use pure carbon disulphide. The enhanced oil recovery solvent may for example comprise a substantial amount of carbon dioxide and/or carbonyl sulphide. Therefore, the carbon disulphide injected may be in the form of a mixture with carbon dioxide formed in step (b) and unreacted carbonyl sulphide. Also other liquid and/or gaseous components or streams may be mixed with the carbon disulphide before the carbon disulphide is injected into the oil reservoir, such as hydrogen sulphide, nitrogen, carbon monoxide, or other sulphur compounds or hydrocarbons.

Instead of directly injecting the carbon disulphide formed in step (b) into an oil reservoir, all or part of the carbon disulphide formed in step (b) may be first be converted into a salt of a tri or tetrathiocarbonic acid. Such salt may be then be introduced into an oil reservoir for enhanced oil recovery under conditions leading to decomposition of the salt into free carbon disulphide. Enhanced oil recovery by using salts of tri or tetrathiocarbonic acid is known in the art, for example from U.S. Pat. No. 5,076,358, herein incorporated by reference in its entirety. In one embodiment of the invention, part of the carbon disulphide formed in step (b) is reacted with hydrogen sulphide and ammonia to form ammonium thiocarbonate. Ammonium thiocarbonate can for example be prepared as disclosed in U.S. Pat. No. 4,476,113, herein incorporated by reference in its entirety.

### EXAMPLES

Experiments were conducted in a nominal 0.5-inch outside diameter (OD) reactor tube of dimensions 0.41-inch ID (inside diameter)×12-inch long, fabricated from 316 stainless steel. Catalyst beds were 11 inches tall, retained by silanized glass wool. Gas mixtures, 5 mol % each of CO2 and H2S in nitrogen (for Step 1 reaction), or 5 mol % COS in nitrogen (for Step 2 reaction) were purchased from Airgas. Feed rate was measured at STP via a calibrated mass flowmeter (Brooks 5850l) calibrated under N2. Backpressure was controlled by spring loaded backpressure regulator. Pressure was measured by calibrated pressure gauge.

Heating was controlled by 1-inch diameter aluminum block wrapped with electrical tape and controlled via Techne TC-8D Eurotherm temperature controller, and Glass Col OTP 1800 over temperature protection controller.

Reactor effluent was routed to an on-line GC-MS to track breakthrough of reactant. Samples were taken into 1-L TedlarTM sample bags for manual injection (1.0 ml) into a GC with 6-foot by 2-mm ID Porapak Q column (80/100 mesh), equipped with thermal conductivity (TCD) and helium ionization (HID) detectors, and employing helium as a carrier gas. The helium gas inlet pressure was 18 PSI. The oven temperature program consisted of an initial temperature of 40 oC for 3 minutes, ramping up to 75 oC at a rate of 5 deg/minute, ramping to 200 oC at a rate of 15 deg/minute, and holding for 5 minutes. The peak retention times (minute) were: 0.50 (N2), 1.45 (CO2), 5.90 (H2S), 6.50 (H2O), 9.30 (COS), and 19.0 (CS2). The GC response factors were determined by injecting standards purchased from Airgas.

After breakthrough of reactants, columns were regenerated in 50-100 ml/min flowing N2 at a prescribed activation temperature, before reducing flow to set operating conditions for the next reaction experiment.

Results are shown in Table 1 as examples 1-17 for the reaction of H2S and CO2 to form COS, and as examples 18 and 19 for the disproportionation of COS to CS2 and CO2. Materials tested were amorphous silica-alumina (ASA) from CRI at a silica to alumina ratio of 45/45, as well as molecular sieve 3A, and strong acid ZSM-5 molecular sieve. The ASA and ZSM-5 catalysts were crushed and sieved to 10-20 mesh size. The 3A molecular sieve, purchased from Alltech, was 60-80 mesh size. Activation temperature was varied, as was reaction pressure. Conversion was observed to quickly pass through a maximum. Reaction was continued for the period indicated, at which time conversion diminished to 25-50% of maximum value due to saturation of the sorbent with water, reducing the ability to absorb additional water, as required to drive the unfavorable equilibrium associated with reaction (1).

While all materials had some activity for reaction (1) including the required water removal step:

H2S+CO2 [symbol] COS+H2O (1)

best results were obtained with an activation temperature of 300 C and at elevated pressures (250-400 psig), with ASA as catalyst, either with or without the use of MS 3A to effect additional drying.

TABLE 1
Examples 1-17 of COS generation, and examples 18&19 of CS2
formation

| | | | ASA | | | | | | | | |
|---|---|---|---|---|---|---|---|---|---|---|---|
| Ex | | | 45/55 | MS 3A | ZSM5 | Activate | Reaction | Reaction | Feed | Total | Max |
| # | Feed | Product | grams | grams | grams | Temp (° C.) | Temp (° C.) | psig | ml/min* | hours | % Conv |
| 1 | CO2 + H2S | COS | 5.51 | 8.99 | 0.0 | 200 | 90 | 0 | 50 | 1.80 | 3.5% |
| 2 | CO2 + H2S | COS | 5.51 | 8.99 | 0.0 | 200 | 90 | 0 | 100 | 1.75 | 2.4% |
| 3 | CO2 + H2S | COS | 5.51 | 8.99 | 0.0 | 200 | 75 | 0 | 50 | 3.55 | 3.2% |
| 4 | CO2 + H2S | COS | 5.51 | 8.99 | 0.0 | 200 | 60 | 0 | 25 | 7.60 | 3.1% |
| 5 | CO2 + H2S | COS | 5.51 | 8.99 | 0.0 | 200 | 90 | 0 | 100 | 3.97 | 5.5% |
| 6 | CO2 + H2S | COS | 5.51 | 8.99 | 0.0 | 200 | 90 | 0 | 50 | 4.07 | 8.3% |
| 7 | CO2 + H2S | COS | 0.00 | 0.00 | 17.0 | 200 | 90 | 0 | 100 | 6.05 | 4.5% |
| 8 | CO2 + H2S | COS | 0.00 | 0.00 | 17.0 | 300 | 90 | 0 | 100 | 5.82 | 9.9% |
| 9 | CO2 + H2S | COS | 9.11 | 0.00 | 0.0 | 300 | 200 | 0 | 25 | 6.07 | 4.0% |
| 10 | CO2 + H2S | COS | 9.11 | 0.00 | 0.0 | 200 | 200 | 100 | 25 | 4.38 | 8.0% |
| 11 | CO2 + H2S | COS | 9.11 | 0.00 | 0.0 | 200 | 200 | 250 | 25 | 5.53 | 19.6% |
| 12 | CO2 + H2S | COS | 9.11 | 0.00 | 0.0 | 200 | 200 | 400 | 25 | 4.47 | 15.1% |
| 13 | CO2 + H2S | COS | 9.11 | 0.00 | 0.0 | 300 | 200 | 400 | 25 | 4.75 | 17.2% |
| 14 | CO2 + H2S | COS | 9.11 | 0.00 | 0.0 | 300 | 90 | 400 | 25 | 7.40 | 54.8% |
| 15 | CO2 + H2S | COS | 9.11 | 0.00 | 0.0 | 300 | 75 | 400 | 25 | 6.55 | 63.6% |
| 16 | CO2 + H2S | COS | 5.61 | 9.06 | 0.0 | 300 | 90 | 400 | 25 | 7.30 | 63.5% |
| 17 | CO2 + H2S | COS | 5.61 | 9.06 | 0.0 | 300 | 90 | 250 | 25 | 5.63 | 50.2% |
| 18 | COS | CS2 | 9.11 | 0.00 | 0.0 | 300 | 300 | 0 | 25 | 10.20 | 36.1% |
| 19 | COS | CS2 | 9.11 | 0.00 | 0.0 | 300 | 200 | 0 | 25 | 10.00 | 32.7% |

*STP = standard temperature and pressure

Examples 18 and 19 show feed of 5 mol % COS over the ASA catalyst. Again, the reaction can be equilibrium constrained as conversions exceed 30% at elevated temperatures.

2 COS [symbol] CS2+CO2

Concerted water removal is thus an advantage in driving high conversion. The acidic solid (ASA) acts to catalyze the conversion, as can other acidic or basic metal oxides such as gamma alumina.

### Illustrative Embodiments:

In one embodiment, there is disclosed a process for the manufacture of carbon disulphide comprising the following steps reacting carbon dioxide with hydrogen sulphide to form carbonyl sulphide and water; and absorbing at least a portion of the water with a sorbent, leaving a mixture comprising carbonyl sulphide, carbon dioxide, and hydrogen sulphide. In some embodiments, the process also includes contacting at least a portion of the carbonyl sulphide with a catalyst effective for disproportionating carbonyl sulphide into carbon disulphide and carbon dioxide. In some embodiments, the process also includes injecting at least a portion of the carbonyl sulphide into a hydrocarbon containing formation to boost a recovery of the hydrocarbons. In some embodiments, the process also includes injecting at least a portion of the mixture comprising carbonyl sulphide, carbon dioxide, and hydrogen sulphide into a hydrocarbon containing formation to boost a recovery of the hydrocarbons. In some embodiments, the process also includes injecting at least a portion of the carbon disulphide into a hydrocarbon containing formation to boost a recovery of the hydrocarbons. In some embodiments, reacting carbon dioxide with hydrogen sulphide comprises reacting in the presence of a catalyst. In some embodiments, the catalyst comprises the sorbent. In some embodiments, the process also includes removing the sorbent, drying the sorbent, and then recycling the sorbent to remove additional water. In some embodiments, the process also includes injecting a mixture comprising carbon disulphide, carbonyl sulphide, carbon dioxide, and hydrogen sulphide into a hydrocarbon containing formation to boost a recovery of the hydrocarbons. In some embodiments, the sorbent comprises a molecular sieve. In some embodiments, the process also includes a feedstock for the reacting carbon dioxide with hydrogen sulphide comprises natural gas, carbon dioxide, and hydrogen sulphide.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A process for the manufacture of carbon disulphide comprising the following steps:
reacting carbon dioxide with hydrogen sulphide to form carbonyl sulphide and water; and
absorbing at least a portion of the water with a sorbent, leaving a mixture comprising carbonyl sulphide, carbon dioxide, and hydrogen sulphide.

2. The process of claim 1, further comprising:
contacting at least a portion of the carbonyl sulphide with a catalyst effective for disproportionating carbonyl sulphide into carbon disulphide and carbon dioxide.

3. The process of claim 1, further comprising:
injecting at least a portion of the carbonyl sulphide into a hydrocarbon containing formation to boost a recovery of the hydrocarbons.

4. The process of claim 1, further comprising:
injecting at least a portion of the mixture comprising carbonyl sulphide, carbon dioxide, and hydrogen sulphide into a hydrocarbon containing formation to boost a recovery of the hydrocarbons.

5. The process of claim 2, further comprising:
injecting at least a portion of the carbon disulphide into a hydrocarbon containing formation to boost a recovery of the hydrocarbons.

6. The process of claim 1, wherein:
reacting carbon dioxide with hydrogen sulphide comprises reacting in the presence of a catalyst.

7. The process of claim 6, wherein:
the catalyst comprises the sorbent.

8. The process of claim 1, further comprising:
removing the sorbent, drying the sorbent, and then recycling the sorbent to remove additional water.

9. The process of claim 2, further comprising:
injecting a mixture comprising carbon disulphide, carbonyl sulphide, carbon dioxide, and hydrogen sulphide into a hydrocarbon containing formation to boost a recovery of the hydrocarbons.

10. The process of claim 1, wherein:
the sorbent comprises a molecular sieve.

11. The process of claim 1, wherein:
a feedstock for the reacting carbon dioxide with hydrogen sulphide comprises natural gas, carbon dioxide, and hydrogen sulphide.
